(19) United States
(12) Patent Application Publication
(10) Pub. No.: US 2004/0215488 A1
(43) Pub. Date: Oct. 28, 2004

(54) Therapy system as well as therapy method

(76) Inventors: Achim Hein, Nurnberg (DE); Robert Setz, Rednitzhembach (DE)

Correspondence Address: MCGLEW & TUTTLE, PC, 1 SCARBOROUGH STATION PLAZA, SCARBOROUGH, NY, 10510-0827, US

(21) Appl. No.: 10/424,262

(22) Filed: Apr. 28, 2003

(51) Int. Cl. G06F 17/60

(52) U.S. Cl. 705/2

(57) ABSTRACT

A therapy system features at least one therapist computer to create or maintain therapy programs and at least one patient computer. In the course of the therapy, the patient computer is connected with a therapy sensor that again is connected with the therapist computer via a data network. A communication module controls the data flow from the therapist computer to the patient computer. The communication module is designed in such a way that in the beginning of a therapy session a configuration packet is transmitted from the therapist computer to the patient computer that manages the release of at least one certain therapy program already preloaded on the patient computer. Conducting a therapy method using this therapy system, at first a computer-based executable therapy program is created and installed on at least one patient computer. Then a therapy plan is created, therapy information that mirror the therapy plan are transmitted from the therapist computer to the patient computer. Then, this therapy plan is executed by the patient via the patient computer. Configuration data are transmitted as therapy information that in the beginning of a therapy session control the release of at least one certain therapy program already preloaded on the patient computer. Therapy system and therapy method only require little effort concerning the data communication when adapting the therapy.

### BACKGROUND OF THE INVENTION

1. Field of the Invention

The invention relates to a therapy system comprising at least one therapist computer for the processing of therapy programs and at least one patient computer that is in the course of the therapy connected at least temporarily with a therapy sensor and with the therapist computer via a data network. The invention further relates to a therapy method comprising the steps of creating at least one therapy program that can be executed with the aid of a computer; installing the therapy program on at least one patient computer, producing a therapy plan; transmitting therapy information that represents the therapy plan from the therapist computer to the patient computer; executing the therapy plan by the patient with the aid of the patient computer.

2. Background Art

Such a therapy system as well as such a therapy method are known in the market under the name of “teletherapy”. Using teletherapy, the patients are no longer reliant on treatment in a clinic but can do a predetermined therapy training in their homes. Thus, certain therapy programs or parts of them as well as certain therapy exercises are performed with the aid of a computer, the so-called patient computer, the patients have access to. The therapy programs respectively therapy exercises can be neuropsychological, neurological or orthopaedic training programs, also from internal medicine, as well as for monitoring vital parameters. Therapy programs like this are well-known. Particularly along with the orthopaedic training programs, as a rule, a training device is provided that is connected with the patient computer via a therapy sensor. In this way, the execution of the therapy program, recorded by the patient computer, is ensured.

Particularly with long-term therapies, it is necessary to adapt the therapy programs to be executed to the therapy progress of the patients respectively to any change of circumstances that have an impact on the training process. Conventional therapy systems respectively therapy methods dispose of the matter by transferring a new therapy program via the therapist computer to the patient computer. Transmissions like this are very time-consuming and normally require the interaction of the patient who has to control the whole procedure. Thus, the transmission security is put at risk. Besides, after successful transmission, the patient must install the therapy program himself which puts him in the undesired position to influence parameters that control the program.

### SUMMARY OF THE INVENTION

Consequently, it is an object of the present invention to enhance a therapy system of a kind as mentioned above in such a way that the adaption of a therapy program to be executed can be done in a simpler and securer way.

According to the invention, this object is attained in a therapy system wherein a communication module controlling the data flow between the therapist computer and the patient computer is designed such that in the beginning of a therapy session, a configuration packet is transmitted from the therapist computer to the patient computer that controls the release of at least one particular therapy program already preloaded on the patient computer.

For the purpose of this claim, the term “therapy program” also refers to parts of therapy programs as well as therapy exercises.

As computers, both therapist computers and patient computers that is, Fat Clients could come into consideration.

With the communication module according to this invention, the need to transfer a completely new software from the therapist computer to the patient computer in order to achieve a change in the therapy program does not arise anymore. The configuration packet contains all necessary data to modify the therapy and the amount of data to be transferred is much smaller in comparison to a completely new therapy program. Thus, modifying the therapy can be done with much less effort concerning the transmission. After transmission, the new therapy is ready for use. As there is no need to do any configuration on the part of the patient, the security standard of the therapy program is kept on a high level.

When the patient computer is connected with an identification module to identify the patient, the identification module leads to a higher security level of the therapy system. Authorised people only have access to a patient computer. By means of an identification card, a cost-effective way of identification has been realised.

Using an identification module leads to an even higher level of system security, when the identification module is designed in such a way that the therapy can only take place whilst the identification module has access to the identification card.

When the communication module is designed in such a way that, after identification of the patient, the therapy program is automatically released, such automatic release of the therapy program simplifies the handling of the therapy program in a way that the patients can completely focus on the therapy itself.

When the communication module is designed in such a way that, via the configuration packet, data are transmitted that represent a maximum number of repetitions of the corresponding therapy program, frequently setting certain therapy program parameters when adapting the therapy can easily be put into practice.

When the communication module is designed in such a way that, via the configuration packet data are transmitted that represent the specific, individually patient-orientated therapy information of the corresponding therapy program, it is possible to satisfy the individual needs of any patient. Specific, individually patient-oriented therapy information, e.g. are instructions on how to carry out the therapy programs which on one hand can be a result of supervision by the therapist, on the other hand results of previously executed therapy programs.

The communication module being designed in such a way that, additionally to the configuration packet, messages between the therapist and the patient can be transmitted, therapists and patients can easily get into contact.

The communication module is designed in such a way that the configuration packet, during transmission from The therapist computer to the patient computer, is cached on a server, which relieves the data traffic within the therapy system. Therapist's and patient computers do not have to be in direct contact whilst performing the therapy.

The communication module being designed in such a way that, in the end of a therapy session, a data packet containing the results is transmitted from the patient computer to the therapist computer, execution of the therapy program can be controlled.

The advantages of using a server are obvious in a communication module designed in such a way that the data packet containing the results is cached on the server during transmission from the patient computer to the therapist computer.

A result packet that gives the therapist a direct feedback on the therapy progress consists in that the communication module is designed in such a way that, via the data packet containing the results, other data are transmitted representing the performance of the patient when executing the corresponding therapy program.

When the communication module is designed in such a way that, via the data packet containing the results, other data are transmitted representing the specific, individually patient-orientated information on the results achieved with the corresponding therapy program, this result packet itemises the patient-specific process and offers the therapist a closer look on certain behaviour patterns of the patients whilst doing their exercises. From this the therapist can draw conclusions about how to conduct therapies in the future.

A communication module that cooperates with a data encryption and data decoding module features a higher level of data security.

The therapist computer featuring a data management module for managing the data of the therapist computer, this simplifies the handling of the data generated during the therapy.

When the data network is one of a group containing a frame relay (FR) or a virtual personal network (VPN) as data network, this provides for a secure data transfer with a sufficiently high data transfer rate required by the therapy system. As a matter of principle, all other known data networks can be used.

Another object of the invention motioned in the beginning is to enhance a therapy method in a way that the effort adapting the therapy is reduced.

According to the invention, this object is attained by a therapy method wherein configuration information is transmitted as therapy information that in the beginning of a therapy session manages the release of at least one particular therapy program already preloaded on the patient computer the advantages of the therapy method according to the invention correspond with those advantages stated in connection with the therapy system mentioned above.

An adaptation of the configuration information, which is put into practice via the information on the results, offers the possibility to individually adjust the therapy to future developments concerning the patients.

An embodiment of the invention will now be illustrated by way of example with the accompanying drawings.

### BRIEF DESCRIPTION OF THE DRAWINGS

FIG. 1 is a schematic overview of the therapy system according to this invention;

FIG. 2 is a schematic illustration of a part of the training system of FIG. 1 which demonstrates internal details of the computers involved;

FIG. 3 is an operation schema of the therapy method according to this invention;

FIG. 4 is a table illustrating a configuration packet that comes into operation within the therapy system;

FIG. 5 is a tree structure that illustrates the internal data management of a therapist computer and a patient computer;

FIG. 6 is a screenshot of a log-on user interface on the therapist computer;

FIG. 7 is a screenshot of a change-password user interface on the therapist computer;

FIG. 8 is a screenshot of an administration user interface on the therapist computer;

FIG. 9 is a screenshot of a user-administration user interface on the therapist computer;

FIG. 10 is a screenshot of a processing user interface on the therapist computer;

FIG 11 is a screenshot of a log-on user interface on the therapist computer;

FIG. 12 is a screenshot of a processing user interface on the therapist computer;

FIG. 13 is a screenshot of a therapist-menu user interface on the therapist computer;

FIG. 14 is a screenshot of a therapist-module user interface on the therapist computer;

FIG. 15 is a screenshot of a journal user interface on the therapist computer;

FIG. 16 is a screenshot of a filter user interface on the therapist computer;

FIG. 17 is a screenshot of a printer user interface on the therapist computer;

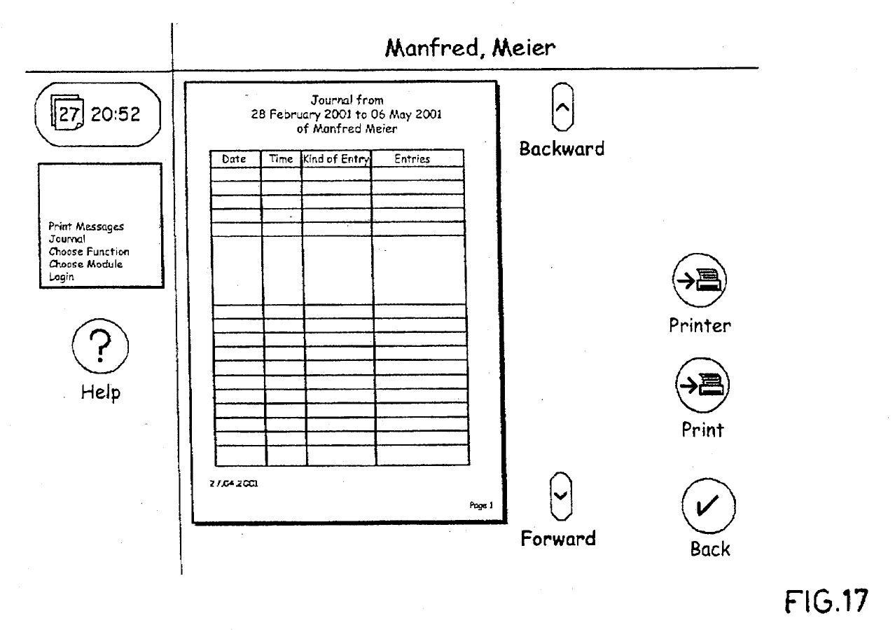

FIG. 18 is a screenshot of a prescription user interface on the therapist computer;

FIG. 19 is a screenshot of a prescription user interface on the therapist computer;

FIG. 20 is a screenshot of a new-prescription user interface on the therapist computer;

FIG. 21 is a screenshot of a new-prescription user interface on the therapist computer;

FIG. 22 is a screenshot of a processing user interface on the therapist computer;

FIG. 23 is a screenshot of a printer user interface on the therapist computer;

FIG. 24 is a screenshot of a printer-menu user interface on the therapist computer;

FIG. 25 is a screenshot of a therapy-administration user interface on the therapist computer;

FIG. 26 is a screenshot of a message user interface on the therapist computer;

FIG. 27 is a screenshot of a sender user interface on the therapist computer;

FIG. 28 is a screenshot of a receiver user interface on the therapist computer;

FIG. 29 is a screenshot of a patient-account user interface on the therapist computer;

FIG. 30 is a screenshot of an addition user interface on the therapist computer;

FIG. 31 is a screenshot of a diagnosis user interface on the therapist computer;

FIG. 32 is a screenshot of a sender user interface on the therapist computer;

FIG. 33 is a screenshot of a start screen on the patient computer;

FIG. 34 is a screenshot of a message screen on the patient computer;

FIG. 35 is a screenshot of a response user interface on the patient computer;

FIG. 36 is a screenshot of an exercise-selection user interface on the patient computer;

FIG. 37 is a screenshot of an exercise-selection user interface on the patient computer;

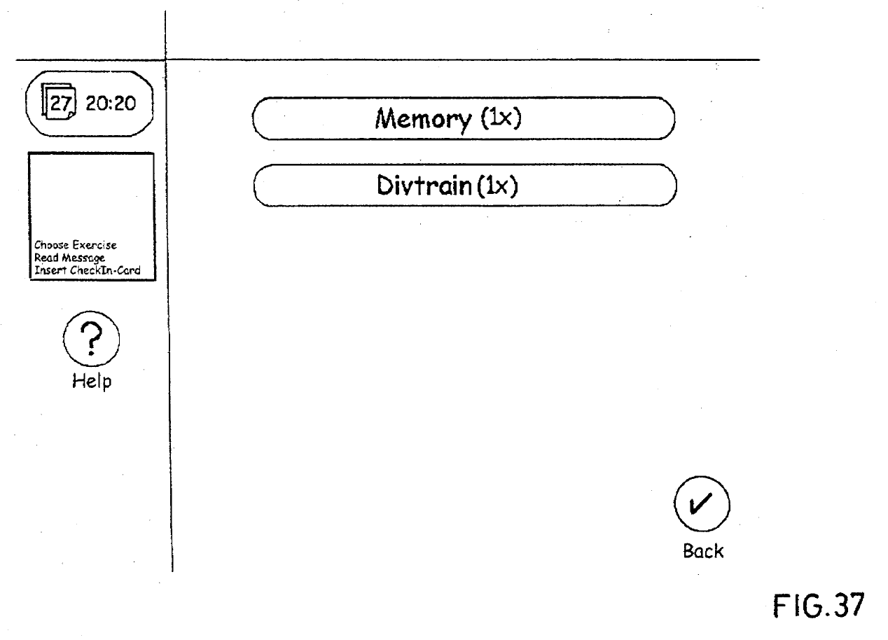

FIG. 38 is a screenshot of an interaction screen on the patient computer;

FIG. 39 is a screenshot of an information screen on the patient computer;

FIG. 40 is a screenshot of an exit screen on the patient computer;

### DESCRIPTION OF A PREFERRED EMBODIMENT

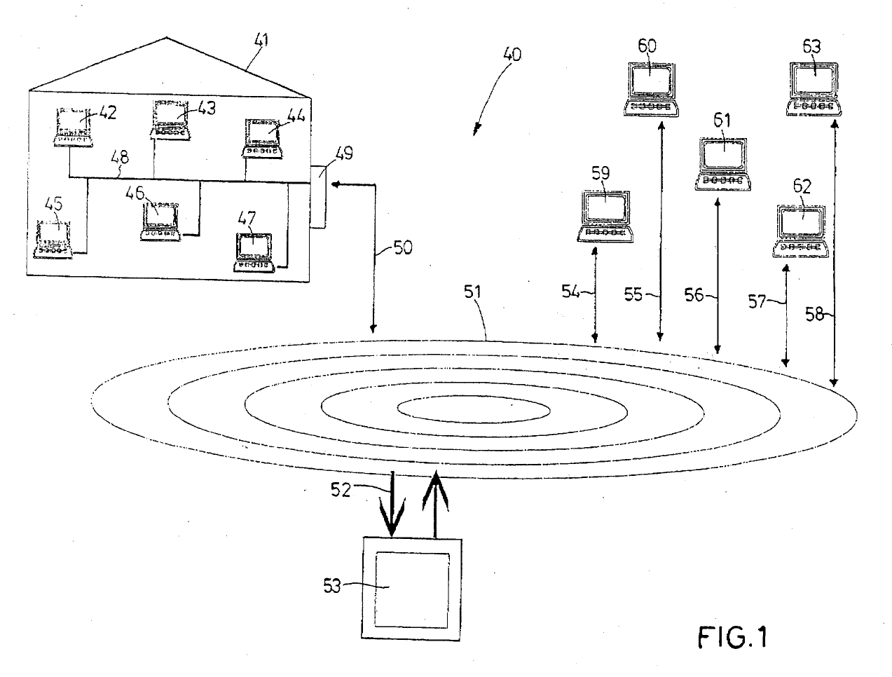

FIG. 1 offers an overview on the therapy system indicated with the reference symbol 40. A clinic with an amount of therapist computers 42, 43, 44 (in example “FIG. 1” there are three altogether) that are connected via a Local Area Network (LAN) 48 with an amount of patient computers 45, 46, 47(in example “FIG. 1” there are three altogether). Alternatively, instead of a LAN 48, the computers 42 to 47 can also he connected via a telephone circuit via the telephone system of the clinic 41.

Given a telephone connection via a telephone system, by means of an interface unit 49, the LAN 48 is connected via a bi-directional communication channel 50 with a Frame Relay (FR) 51. The Frame Relay 51 establishes a connection to a server 53 via a bi-directional communication channel 52. Moreover, the FR 51 ensures the connection to more (five altogether in FIG. 1) patient computers 59, 60, 61, 62, 63 outside the clinic 41 via bi-directional communication channels 54, 55, 56, 57, 58.

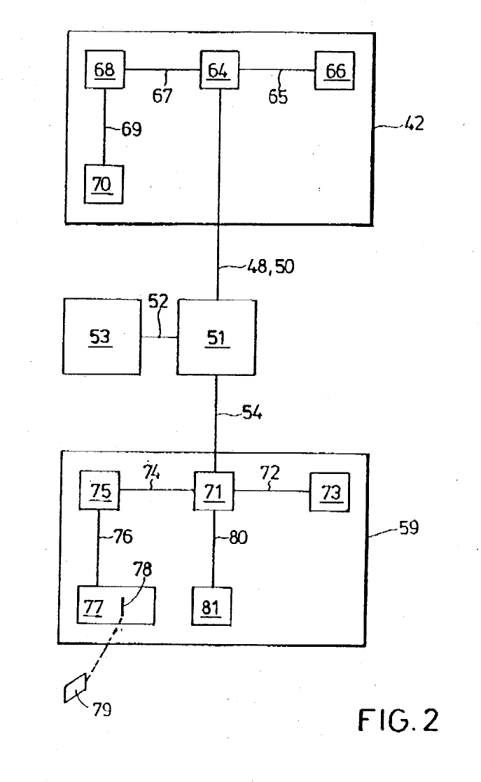

FIG. 2 exemplifies by means of a schematic illustration the internal configuration of the therapist computer 42 and the patient computer 59. Components already described with regard to FIG. 1 bear the same reference symbols in FIG. 2 and will not again be explained in detail.

The therapist computer 42 features a first communication unit 64 the patient computer 42 is connected with, via the LAN 48. By means of a data line 65, the first communication unit 64 is connected with a data encryption and data decoding unit 66. A data line 67 connects the first communication unit 64 with the memory 68 of the therapist computer 42. Via a data line 69, the memory 68 is connected with an administration module 70 of the therapist computer 42.

The therapist computers 43, 44 are set up in the same manner as with therapist computer 42.

The connection of the patient computer 59 with the bi-directional communication channel 54 is established via a second communication unit 71 which is connected via a data line 72 with a second data encryption and data decoding unit 73.

Both communication units 64, 71 together are part of a communication module of the therapy system 40 that controls the data flow between the therapist computers 42 to 44 and the patient computers 45 to 47 and 59 to 63.

A data line 74 connects the second communication unit 71 with the memory 75 of the patient computer 59. The memory 75 is connected via a data line 76 with an identification module 77 of the patient computer 59. The identification module 77 features a card slot 78. An identification card 79 can be inserted into the card slot 78 as illustrated in FIG. 2.

The second communication unit 71 is connected with a therapy sensor 81 via a data line 80. The therapy sensor 81, in the simplest case, can be the keyboard or the mouse of the patient computer 59. For example, alternative therapy sensors can be any external neuropsychological or orthopaedic training units connected with the patient computer 59 via the data line 80. An example for such training units is an ergometer that can be controlled and/or configured via data transmission on the part of the patient computer 59. Alternatively to a connection of the therapy sensor 81 with the patient computer 59 via the data line 80, such a connection can also be made available only occasionally, realised for example by means of a chip card that can be inserted either in the patient computer 59 or in the therapy sensor 81. The patient computer 59 can also be integrated into the therapy sensor 81.

The patient computers 60 to 63 are set up in the same manner as with the patient computer 59. Except for the type of data connection to the therapist computers, the patient computers 45 to 47 as well feature the same internal configuration as the patient computer 59 displayed in FIG. 2.

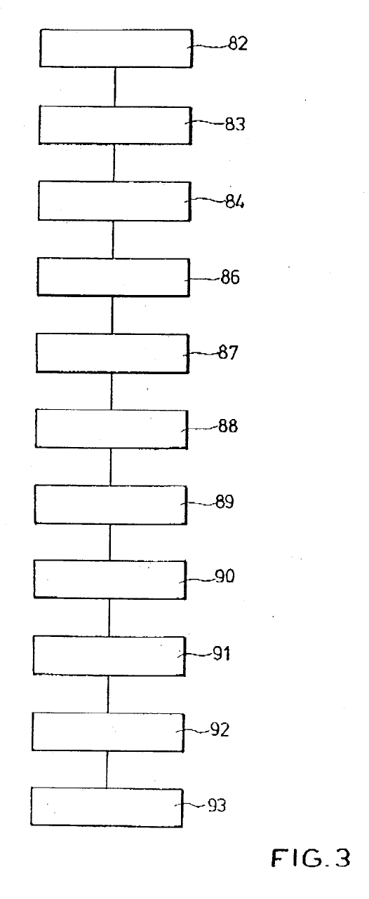

FIG. 3 illustrates the procedure of a therapy method by means of an operation schema that can be performed with the therapy system 40: In a programming step 82, a program developer (who can be a therapist as well) creates a therapy program that can be executed by training devices connected via the therapy sensors 81 with the patient computers 45 to 47 respectively 59 to 63. The created program is installed to the patient computers 45 to 47 respectively 59 to 63 in an installation step 83.

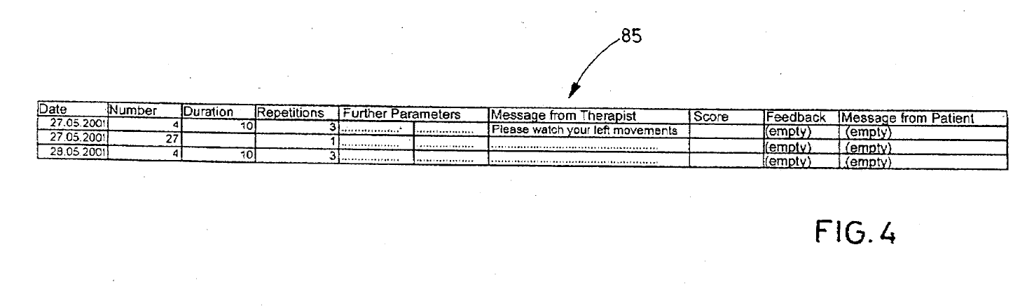

Afterwards, in planning step 84, the therapist creates a therapy plan tailor-made for the corresponding patients. The therapy information, reflecting the therapy plan, entered into the computer by the therapist are compiled by the first communication unit 64 to a configuration packet 85. The configuration packet 85 is exemplified by means of a table in FIG. 4:

The first column on the left (date) of the configuration packet 85 indicates the date the patient has executed the corresponding therapy program. The second column (figure) contains the corresponding number the therapy program executed by the patient can be identified with. The third column (duration) contains a number that predetermines the duration of the execution of the corresponding therapy program. If there is no data entry, the therapy program follows an automatic process. Therefore, input of an execution duration is not obligatory. The fourth column (amount of repetitions) contains numbers that render the quantity of repetitions of the corresponding therapy program that have to executed.

The fifth column (additional parameters) is subdivided in two columns to enter additional data that allow further configurations with certain therapy programs, for example the degree of difficulty of a certain exercise, the predetermined “elbow room” when performing exercises with certain orthopaedic training devices, or kinetic resistance of the training devices. In the sixth column (messages of the therapist) messages from the therapist to the patient can be entered that are supposed to increase the success of the patient when executing the corresponding therapy program. In the seventh column (score) the therapy program automatically enters a number that represents the patient's success after having executed the corresponding therapy program. In the eighth column (feedback) the patient can enter specific therapy information whilst doing his/her exercises. These information are transmitted to the therapist via the configuration packet 85. Entries like this could be as follows: “Whilst exercising, I have noticed the following . . . ” The ninth column on the right (message of the patient) is reserved for other messages from the patient to the therapist.

The created therapy plan in the form of the configuration packet 85 will he encrypted afterwards via the data encryption and data decoding unit 66 and transmitted from the computer that has executed the planning step 84 (e.g. therapist computer 42) via LAN 48, the interface unit 49, the bi-directional communication channel 50, the FR 51 as well as the bi-directional communication channel 52 to the server 53 (step 86). By means of the therapist computers (e.g. therapist computer 42) not only creation and maintenance of therapy plans respectively therapy programs is possible but also operating them.

Before starting the training, the patient inserts his/her identification card 79 in the card slot 78 of the identification module 77 of the patient computer (e.g. patient computer 59). In an identification step 87 the identification of the patient is performed by the identification module 77. Preferably, the identification module 77 is designed in a way that the therapy can only take place whilst the identification module 77 has access to the identification card 79.

Afterwards in a transmission step 88, the transmission of the configuration packet 85 to the patient computer 59 is carried out via the bi-directional communication channel 52, the FR 51, and the bi-directional communication channel 54. After successful transmission and decoding of the configuration packet 85 by the data encryption and data decoding unit 73, the second communication unit 71 of the patient computer 59 automatically releases those therapy programs specified with the transmitted communication packet 85. This takes place in a release step 89. Afterwards, the patient starts executing the therapy program predetermined by the configuration packet 85. The patient can only repeat the exercises according to the amount predetermined by the configuration packet 85 (fourth column). The execution of the therapy program is done in a therapy step 90. When executing a particular therapy program, the therapy sensor 81 is transmitting the realised results via the data line 80 of the second communication unit 71. The column “Score” of the configuration packet 85 is constantly updated by these results.

After finishing the therapy step 90, the patient can enter data in the two columns on the right hand side of the configuration packet 85.

In a cache step 91 the updated and encrypted configuration packet 85 is transmitted by the second communication unit 71 to the server 53 via the bi-directional communication channel 54, the FR 51, and the bi-directional communication channel 52. Performing a corresponding release order, the therapist can initialise a transmission step 92 that transmits and afterwards decodes the updated configuration packet 85 via the bi-directional channel 52, the FR 51, the bi-directional channel 50, the interface unit 49, and the LAN 48 from the server 53 to the therapist computer 42.

Within the scope of an adaptation step 93, the therapist analyses the data of the updated configuration packet 85. Depending on the values stated in the column “Score”, the feed back of the patient on the corresponding therapy programs and, if necessary, further medical considerations, the therapist performs an adaptation of the configuration packet 85. An adaptation like this means e.g. the replacement of particular therapy programs that did not yield the desired success with more promising ones. Also the duration as well as the amount of repetitions can be adapted. Additional configurations with particular therapy programs can be done in the column “Additional Parameters” during the adaptation step 93.

Now the configuration packet 85, changed within the scope of the adaptation step 93, is encrypted again and transmitted to the server. The therapy method then starts again beginning with the identification step 87 as discussed above.

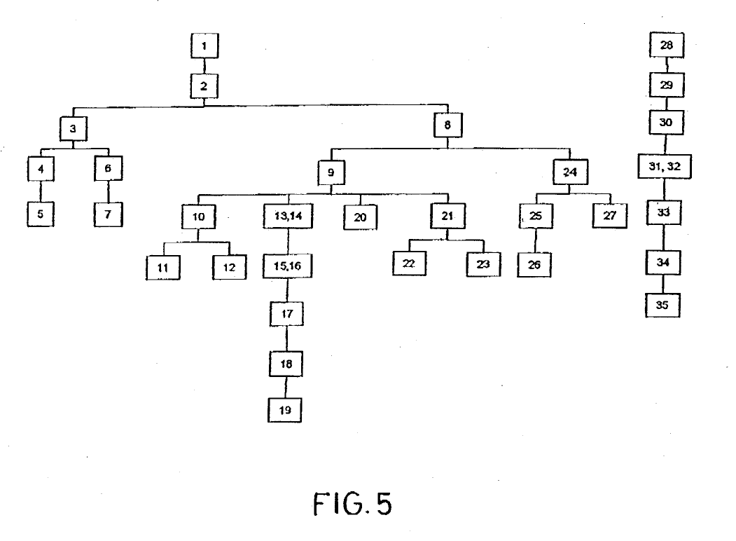

FIG. 5 illustrates the internal structures of the data management within the therapy system. The tree structure on the left in FIG. 5 shows the internal data management structure of the therapist computers 42 to 44. The operation schema of FIG. 5 (right hand side) illustrates the internal data management Structure of the patient computers 45 to 47 and 59 to 63. Those internal data management structures are subdivided into single interaction processes (so-called screenshots) between the computers and the corresponding users. These screenshots mirror the screen displays of the computers involved and are explained in the following.

The data management of the therapist computers 42 to 44 features the following structures:

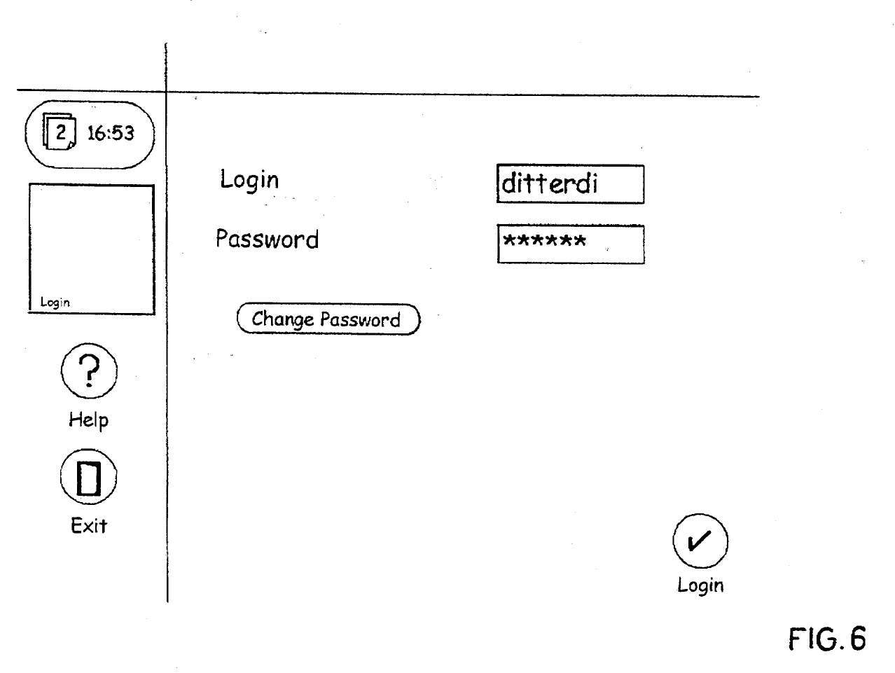

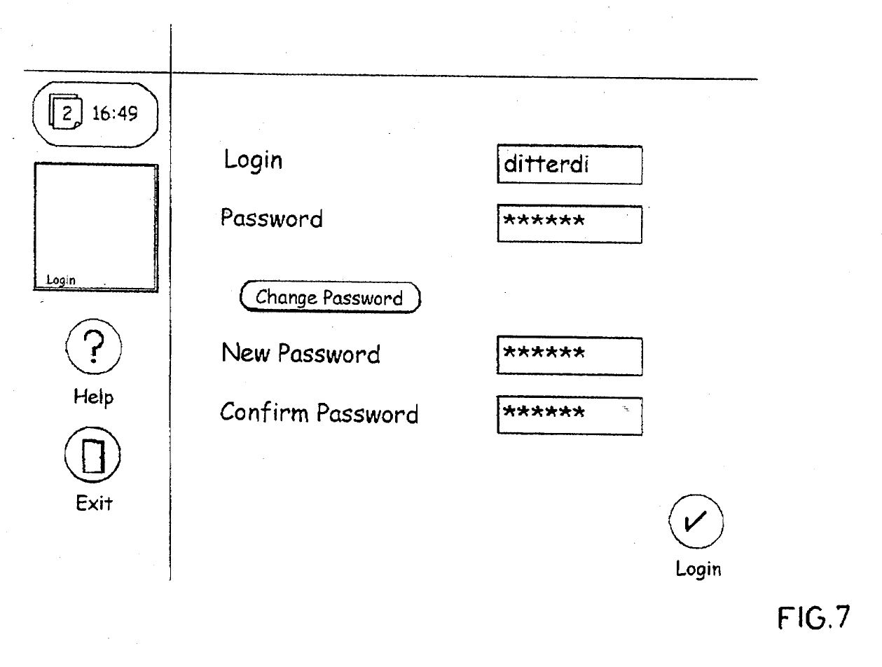

By means of a log-on user interface 1 (FIG. 6), the user is asked for his/her name and a password when starting the therapist computer 42. Via a button “Change Password” that can be activated by mouse click, the therapist can switch from the log-on user interface 1 to a password-change user interface 2 (FIG. 7). Provided that the original password has been accepted, the therapist can enter a new one and confirm it by re-entering it.

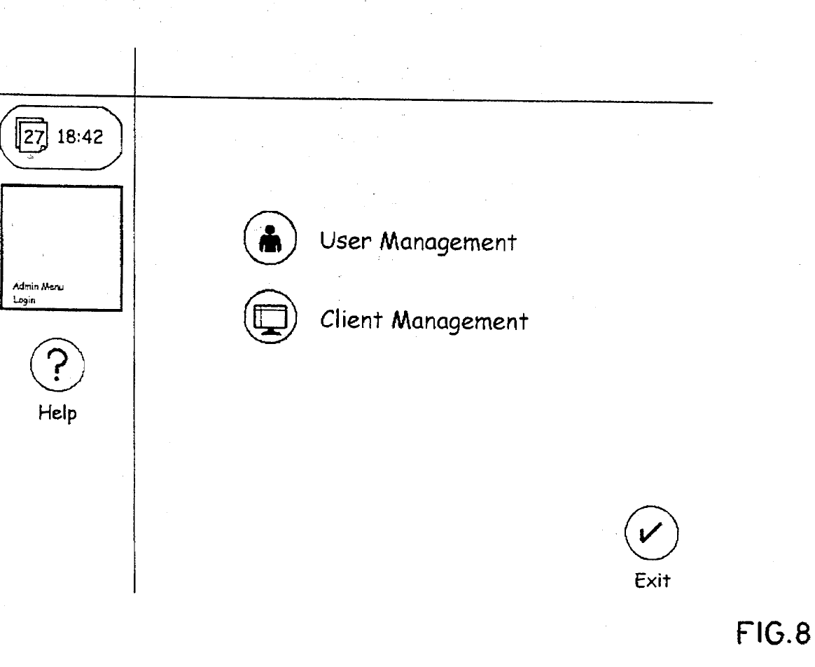

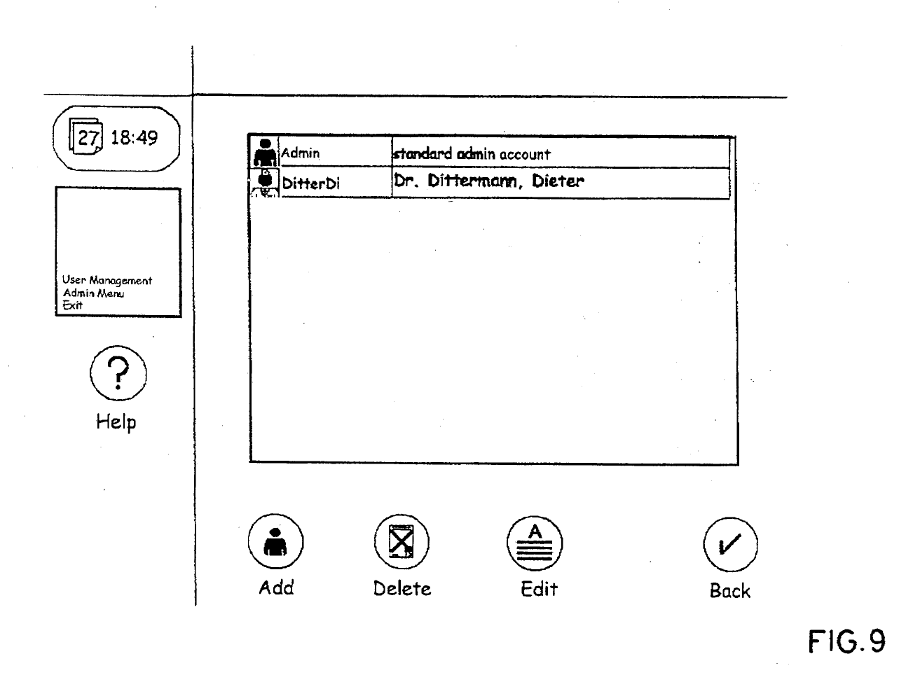

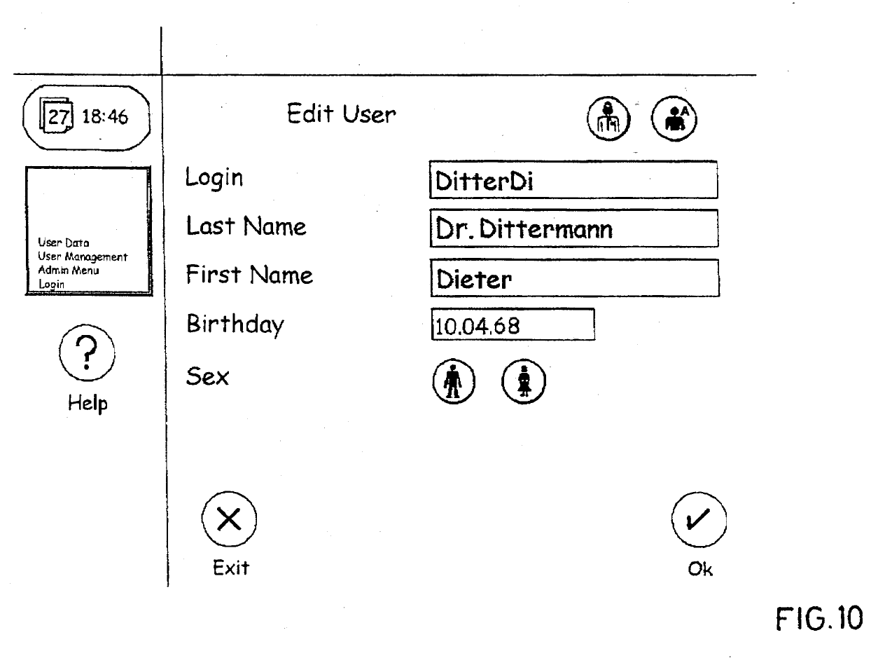

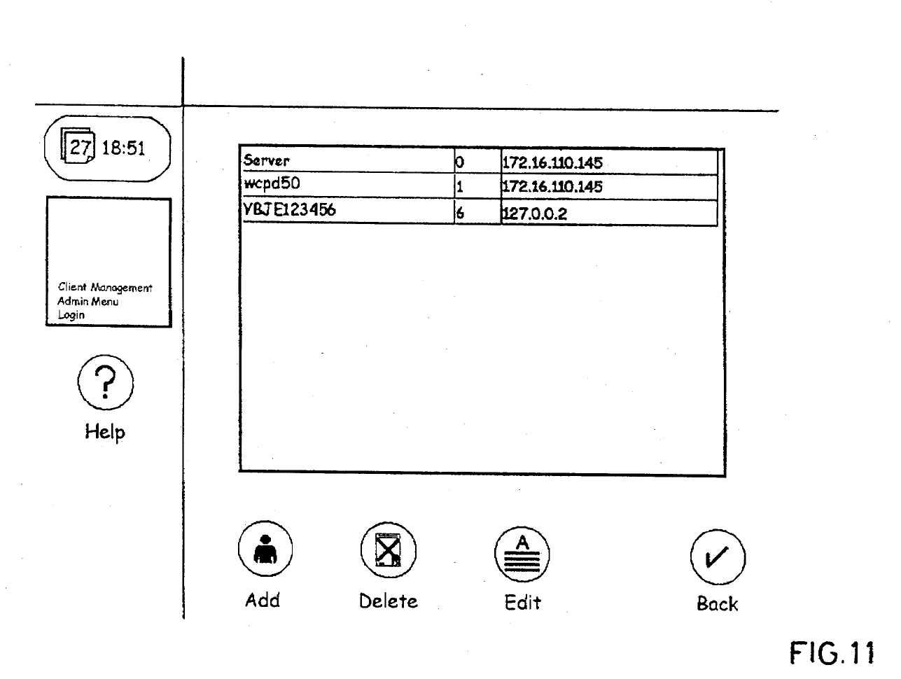

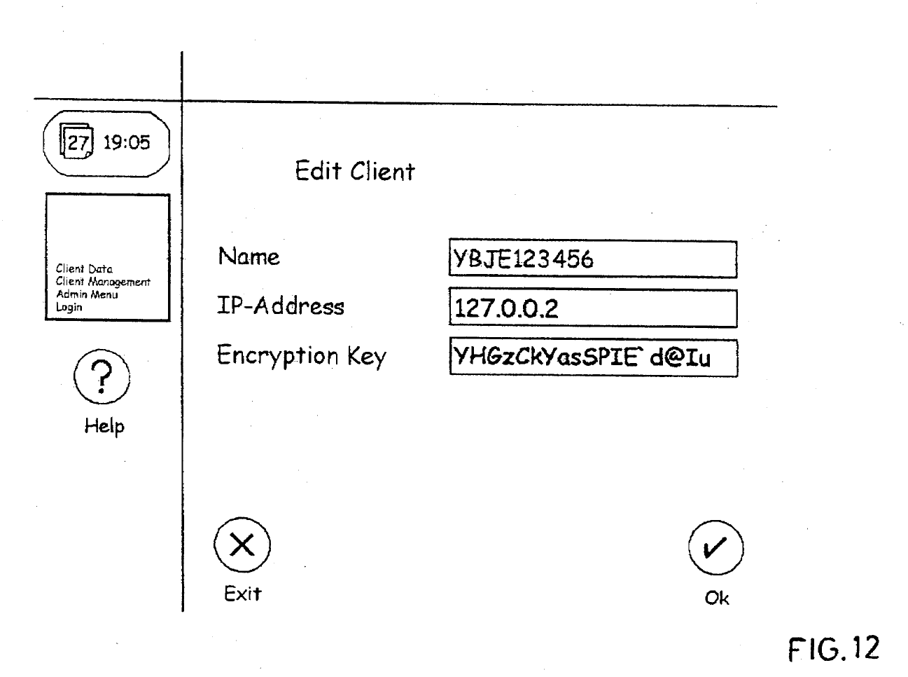

The therapist can switch from the log-on user interface resp, the password-change user interface to the administration user interface 3 (FIG. 8) by activating a button via mouse click. Having done so, the therapist is now in the position to access the user-management user interface 4 (FIG. 9) or the client-management user interface 6 (FIG. 11). Within the user-management user interface 4, the therapist is in the position to switch to an edit user interface 5 (FIG. 10) by clicking on the corresponding user name out of a user list. Here he can enter and save user data (such as last name, first name, birthday, sex). In the same manner as with the user-management user interface, the client-management user interface 7 (FIG. 12) is accessible, where patient's data (such as name, IP-address of the associated patient computer, crypto key of the on this computer installed data encrypting and data decoding unit 66) can be entered or changed.

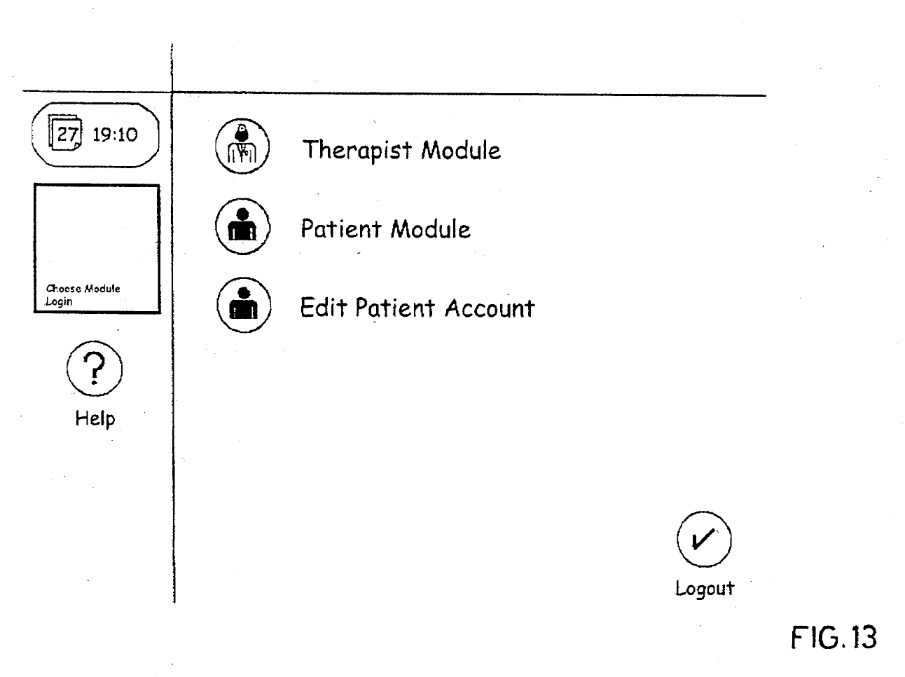

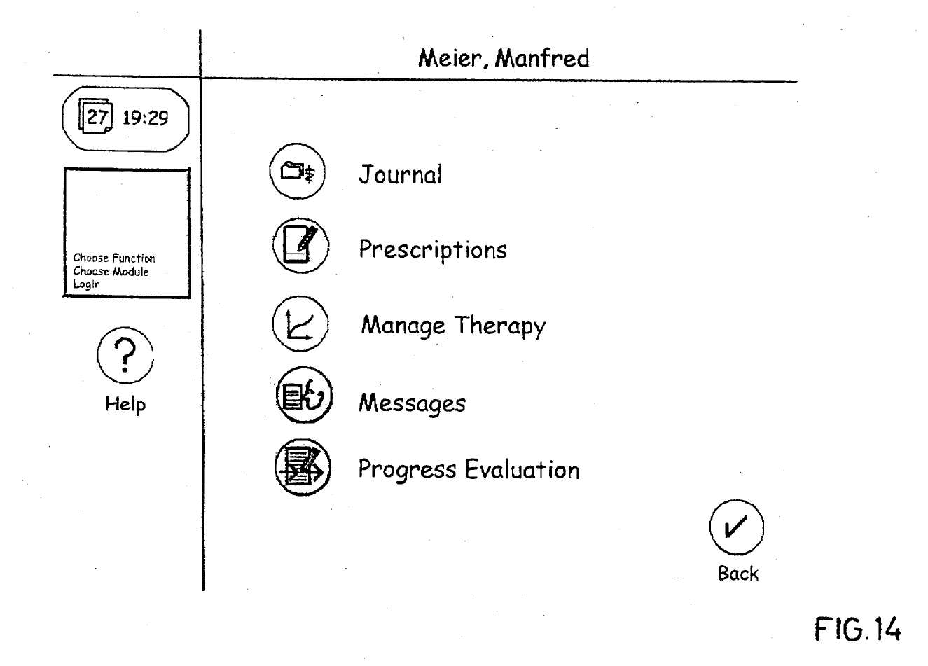

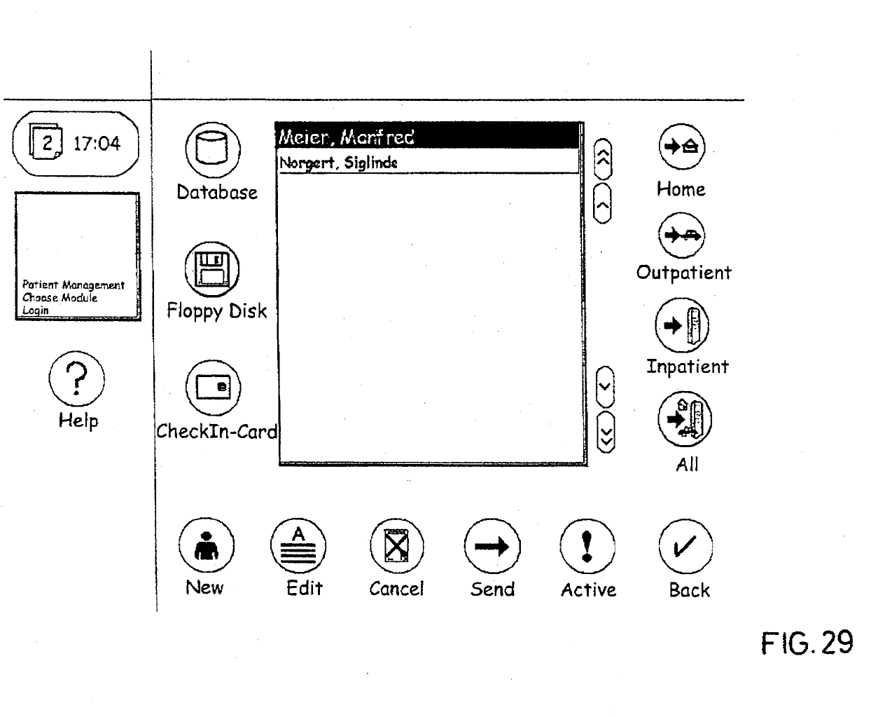

Via mouse click the therapist can switch from the log-on user interface 1 respectively change-password user interface also to a therapist-menu user interface 8 (FIG. 13). From here the therapist can gain access to a therapist-module user interface 9 (FIG. 14) or to a patient-account user interface 24 (FIG. 29).

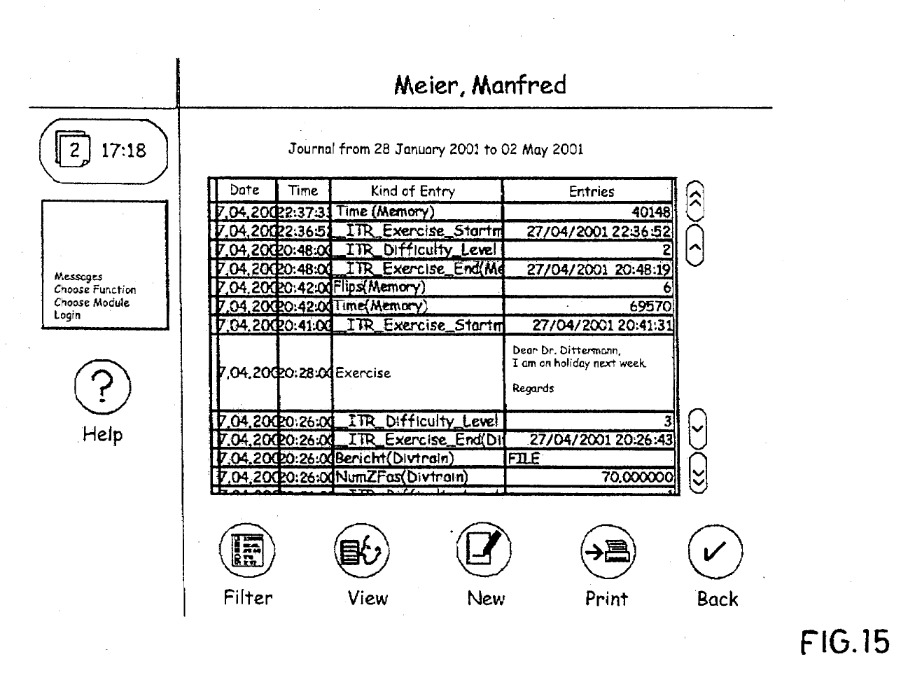

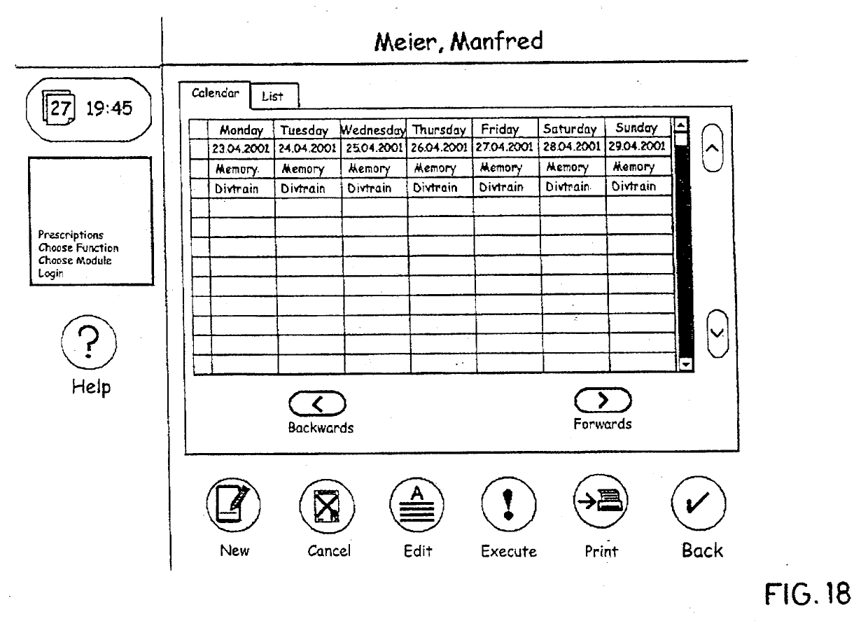

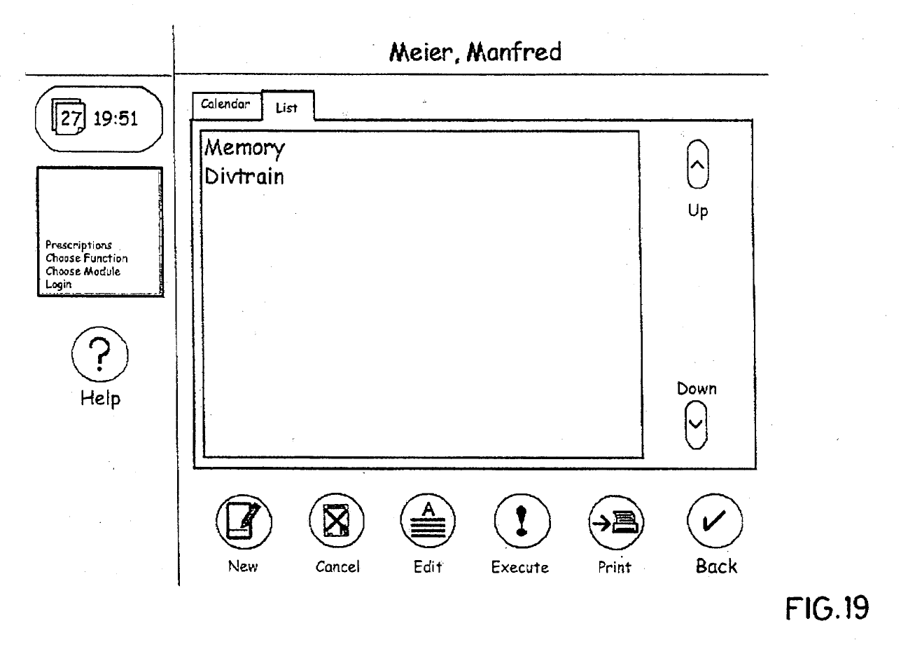

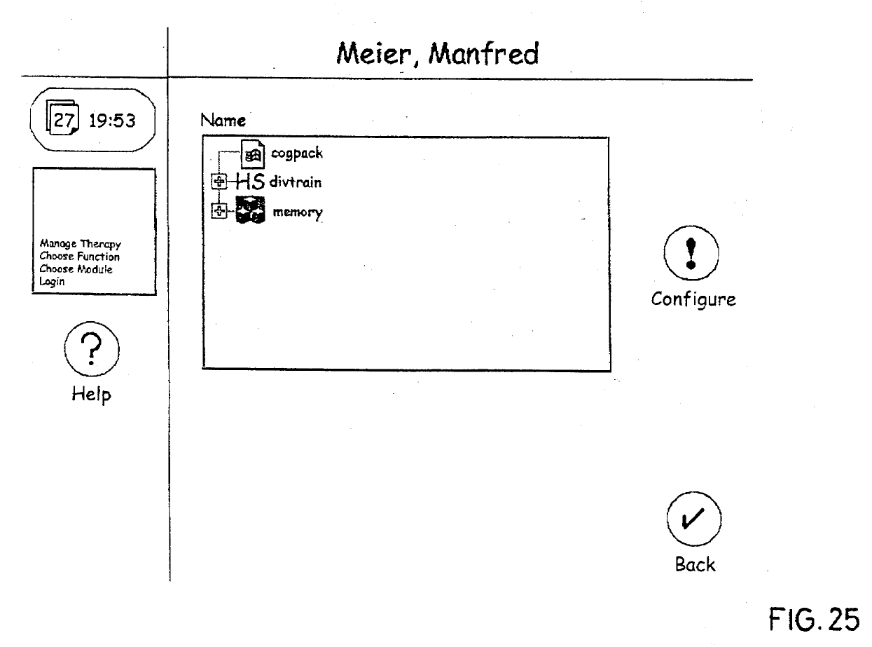

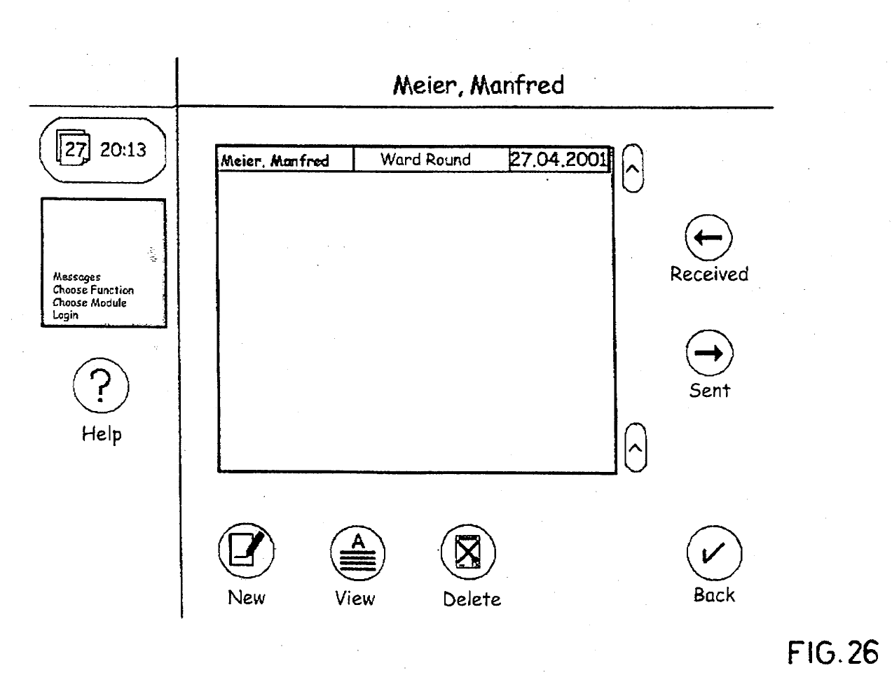

Within the therapist-module user interface 9 the therapist has access to a journal user interface 10 (FIG. 15), to prescription user interfaces 13, 14 (FIGS. 18, 19), to a therapy-management user interface 20 (FIG. 25) or to a message user interface 21 (FIG. 26).

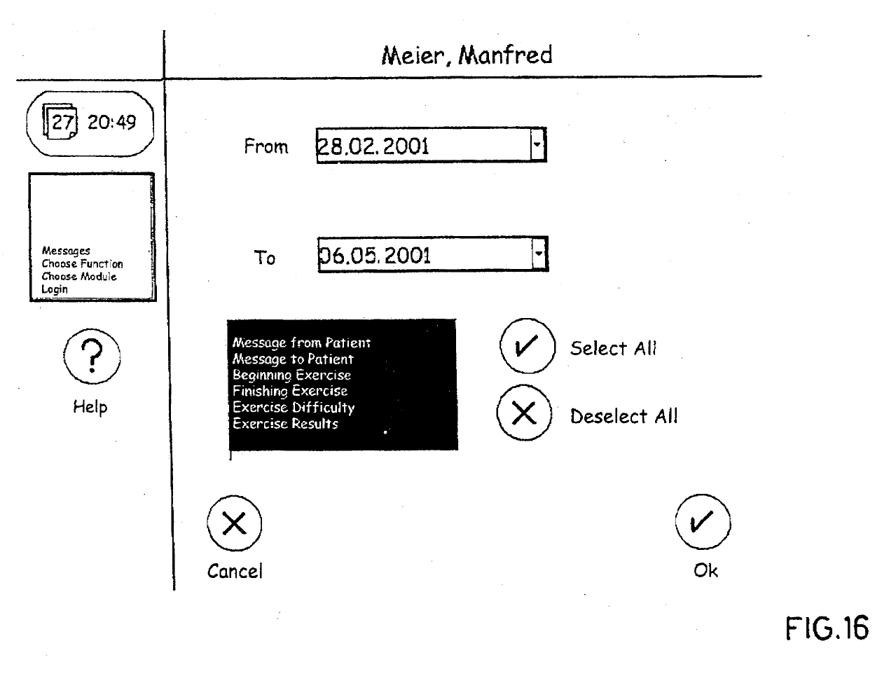

Within the journal user interface 10, the therapist can enter common daily entries, e.g. medical observations. By clicking on a certain button, the therapist can select a filter user interface 11 (FIG. 16) that enables him to choose certain entries just by entering the starting and finishing date.

Within the journal user interface the therapist can select a printer user interface to print out certain journal entries.

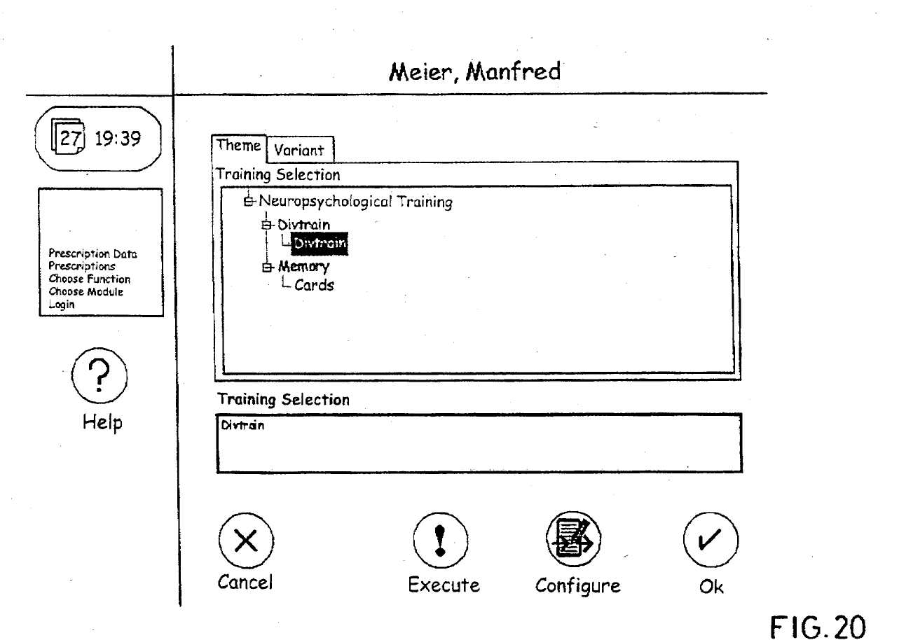

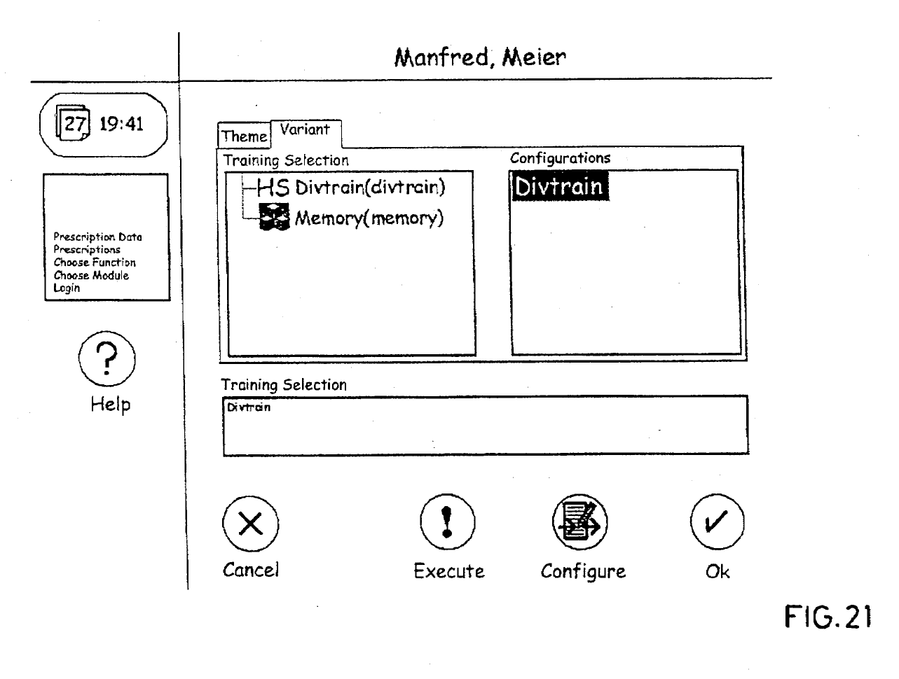

The prescription user interfaces 13, 14 contain the therapy programs to be prescribed to the corresponding patients. Here the therapist can choose between a calendarian (prescription user interface 13) or a listed (prescription user interface 14) presentation. The entries within the prescription user interfaces can be changed and saved by the therapist. This can be done via new-prescription user interfaces 15, 16 (FIGS. 20, 21). Here the therapist is in the position to arrange a general choice of exercises. Now the neuropsychological or orthopaedic training programs within the therapy system 40 can be chosen. Here the therapist can also add specific variants to certain pre-chosen therapy programs.

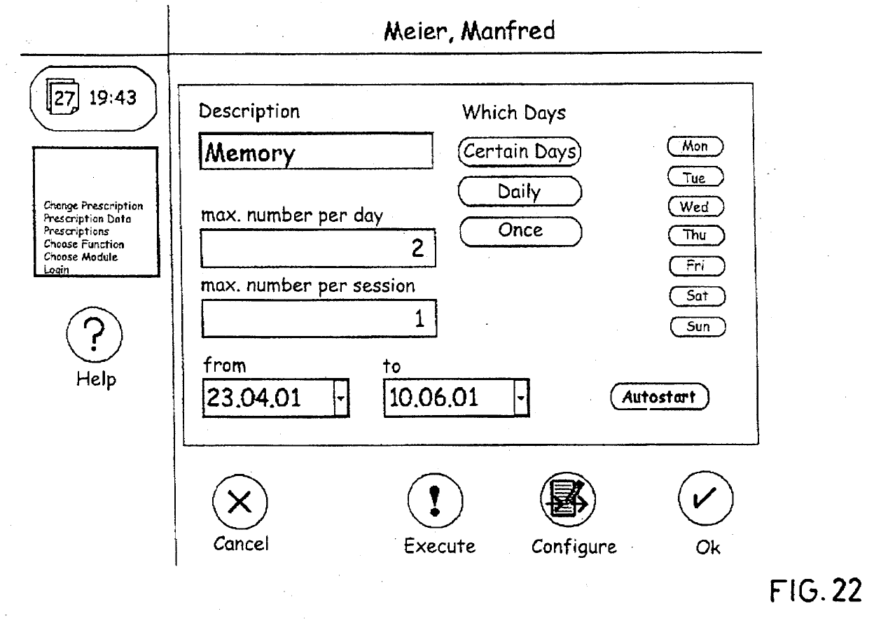

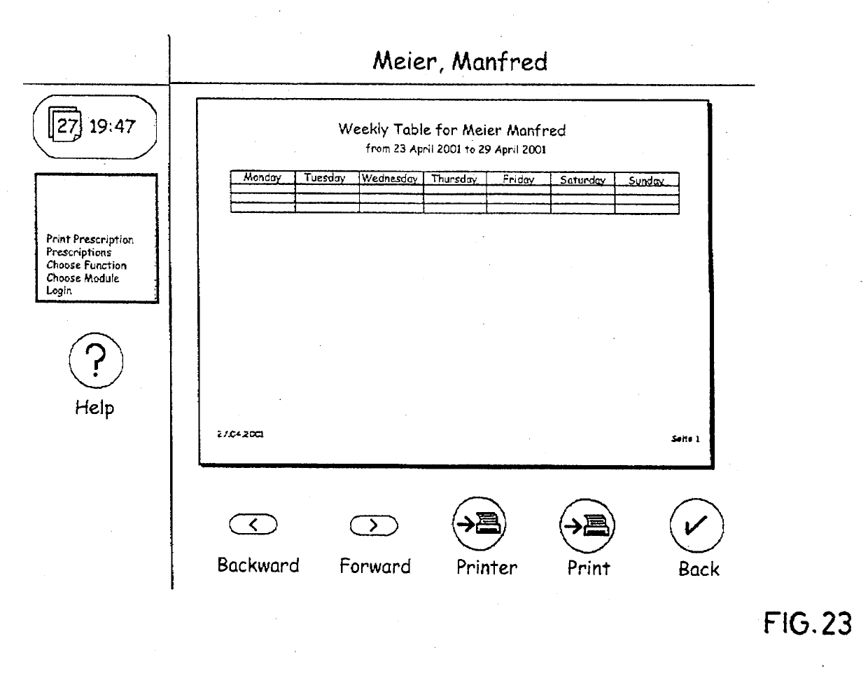

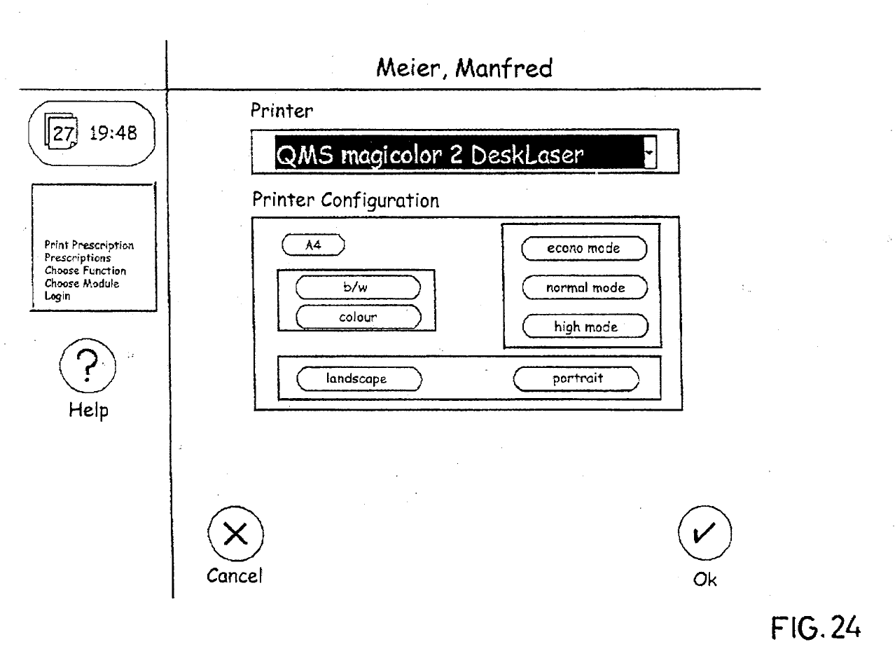

By means of an edit user interface 17 (FIG. 22) the therapist can reach via the new-prescription user interfaces 15, 16, he can arrange the single parameters of therapy programs to be executed by the patients. Certain therapy programs can only be done on certain days, how often they have to be done on one day and how often they have to be done within one single training unit. The prescription can be printed out within the edit user interface 17 by accessing a printer user interface 1 8 (FIG. 23). Via a choose-printer user interface 19 (FIG. 24) that can be reached within the printer user interface 18, the selection of a certain printer driver is possible.

By means of the therapy-management user interface 20, the therapist has access to a summary of all currently active prescriptions for a certain patient.

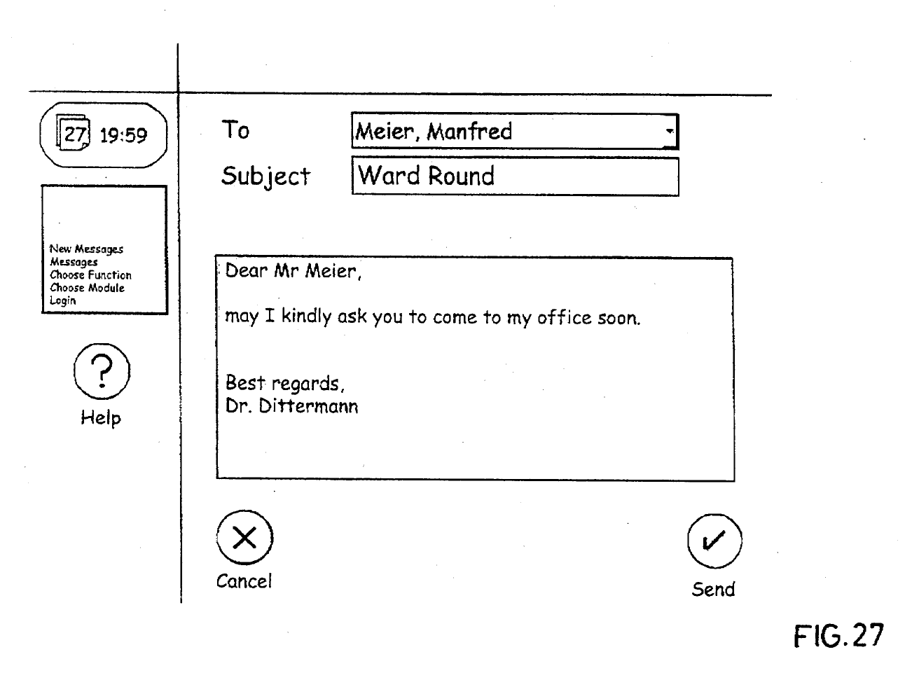

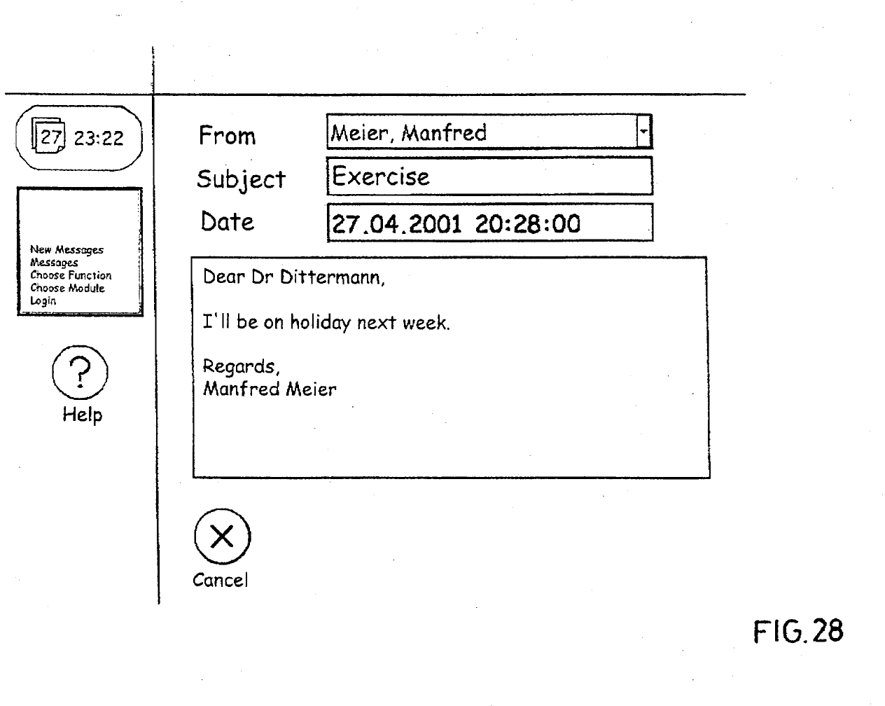

Via the message user interface 21, a sending user interface 22 (FIG. 27) as well as a receiving user interface 23 (FIG. 28) is accessible. Within the sending user interface 22, the therapist can send messages to the corresponding patients. Within the receiving user interface 23, the therapist can receive messages sent to him by the patients.

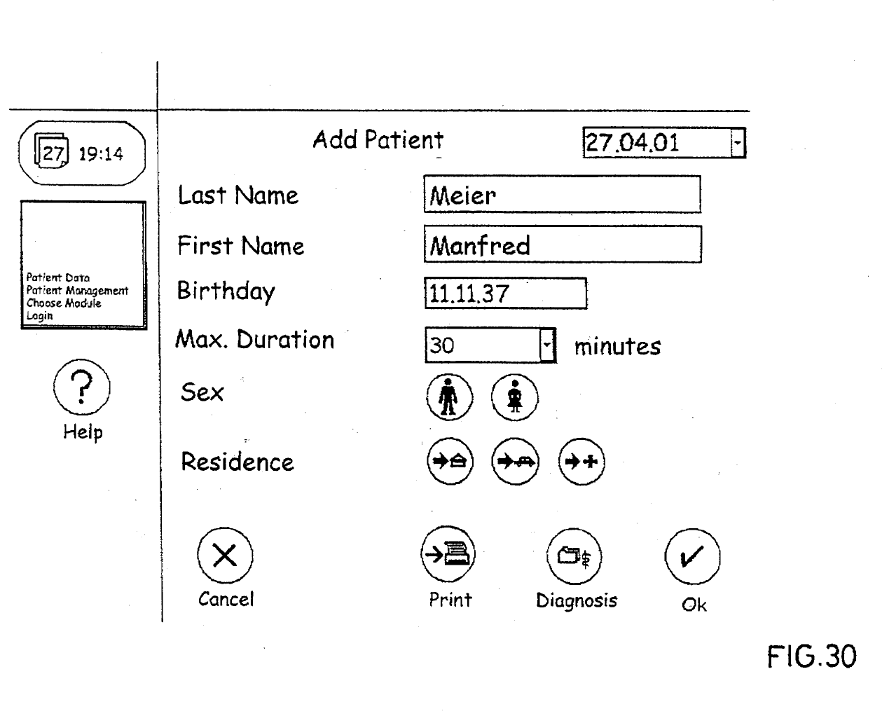

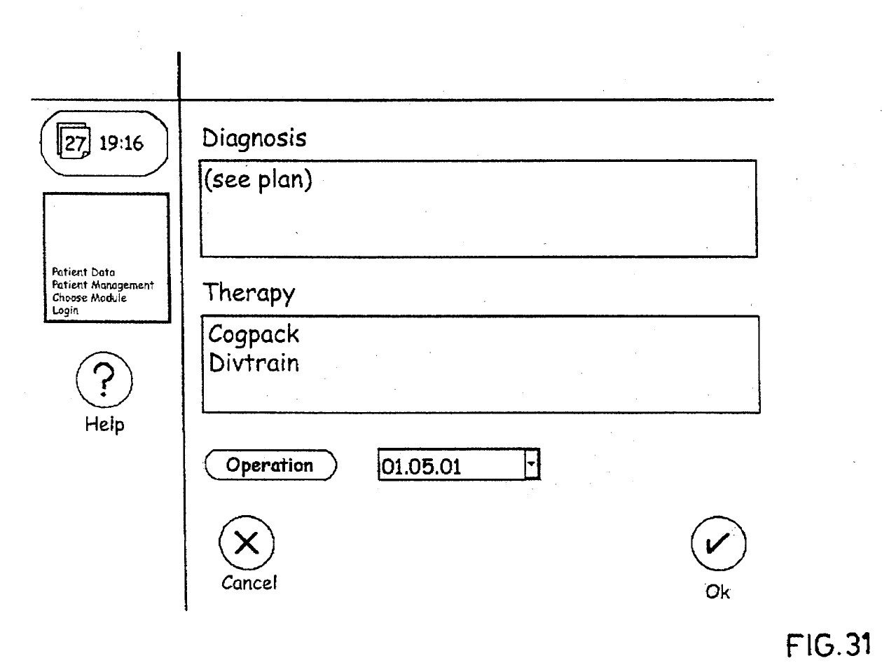

Patient administration is possible via the patient-account user interface 24. At first, the patients to be attended to are listed in table form. Via a button “New” within the patient-account user interface 24, a addition user interface 25 (FIG. 30) can be accessed that allows entering the data of new patients (date of entry, first and last name, birthday, maximum training period, sex, inpatient or outpatient). Within the addition user interface 25 the therapist has access to a diagnosis user interface 26 (FIG. 31) where suggestions concerning diagnoses and therapies can be entered.

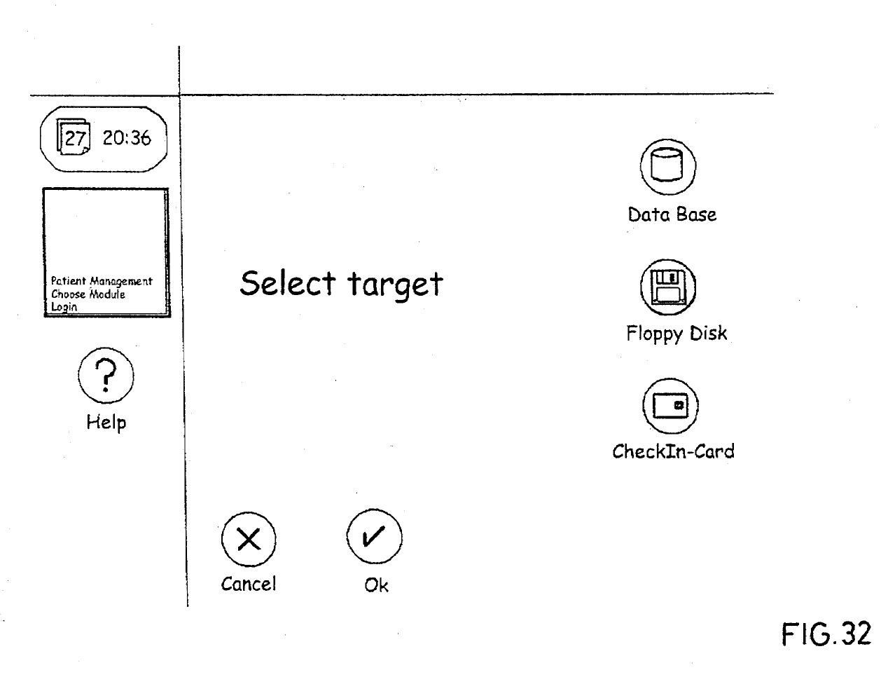

Within the patient-account user interface 24, a sending user interface 27 (FIG. 32) is accessible where the updated patient account can be saved on a selectable storage medium, e.g. a data base, floppy disk, or a certain identification card 79. As identification card 79 or as an alternative storage medium a chip card can be used as well to save data about patients and/or therapies on. If so, the chip card is especially designed to exchange data directly, not via a patient computer that is via a data network with the therapist computers 42 to 44 or the server 53.

The data management of the patient computers 45 to 47 respectively 59 to 63 feature the following structure:

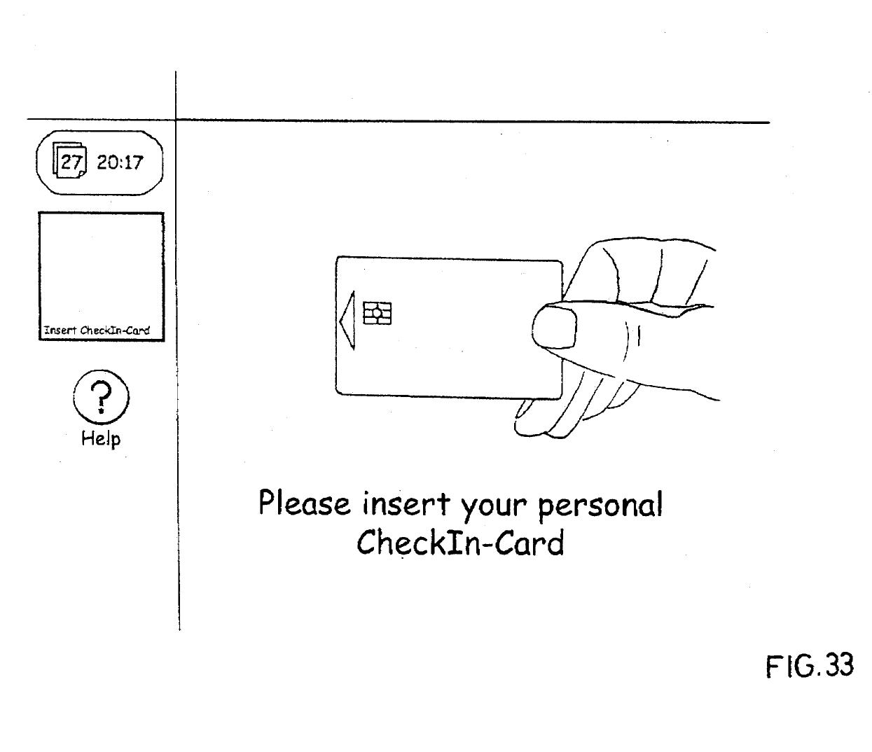

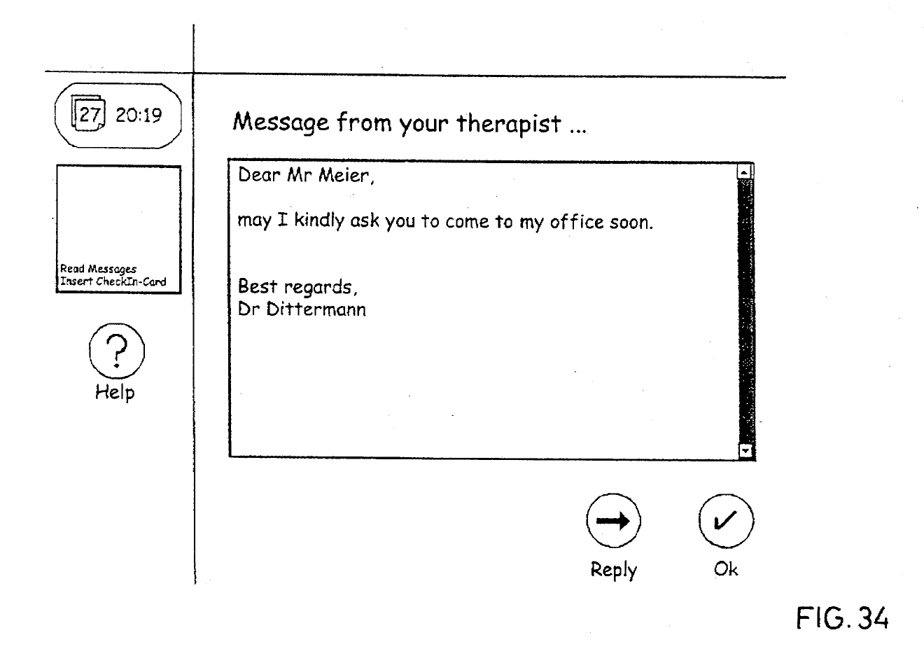

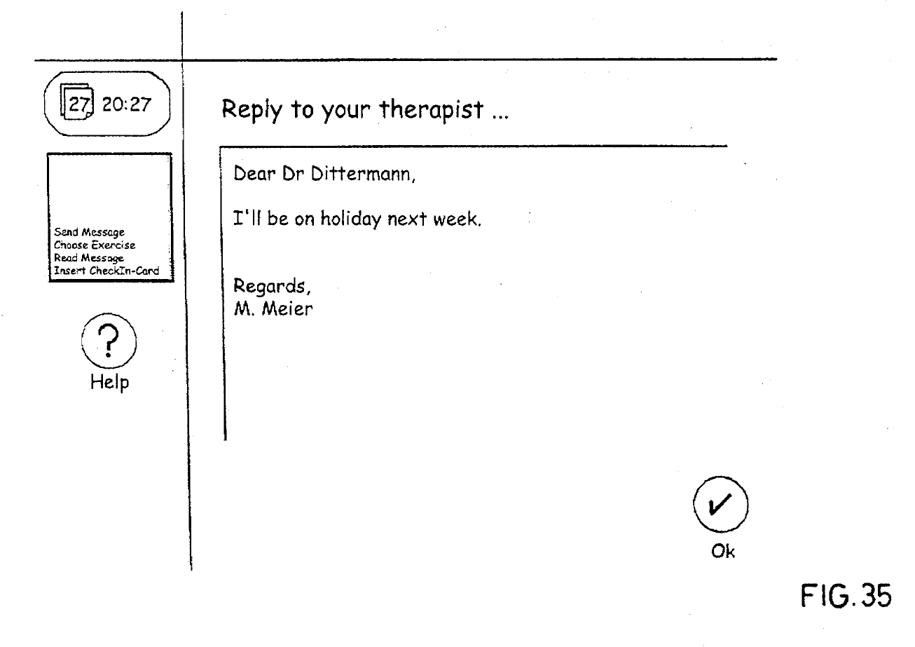

When switching on the patient computer, e.g. patient Computer 42, a start screen 28 (FIG. 33) appears. The patient is asked to insert his/her identification card 79 into the card slot 78 of the identification module 77. After successful identification (identification step 87), messages from the therapist to the patient (if there are any) are displayed on a message screen 29 (FIG. 34). Via a response user interface 30 (FIG. 35) that is accessible via the message screen 29, the patient can send the therapist a written reply. If there are no messages from the therapist, the screens 29 and 30 will be leapt.

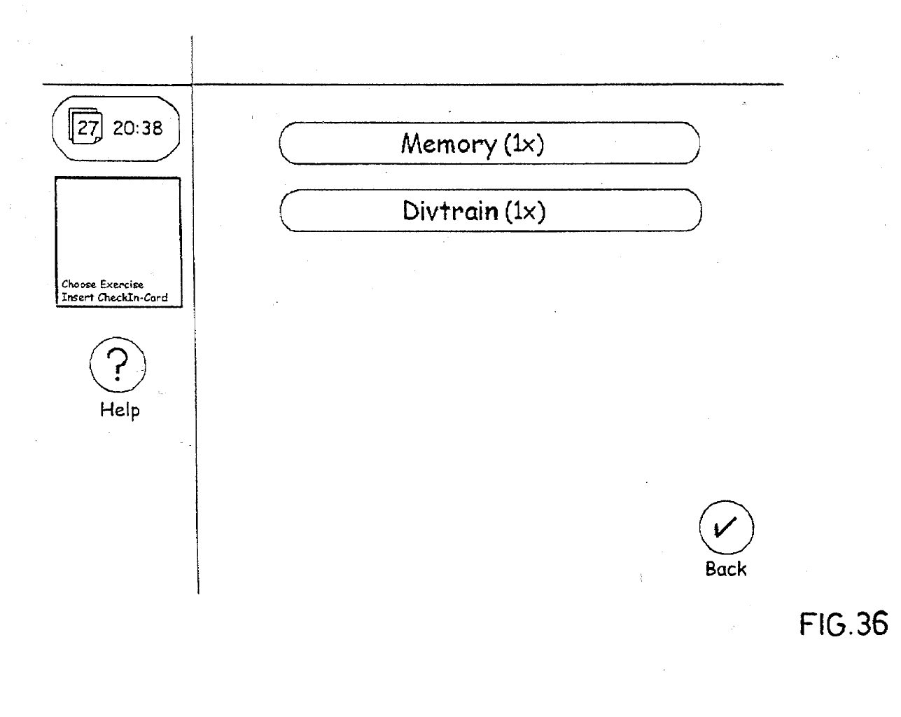

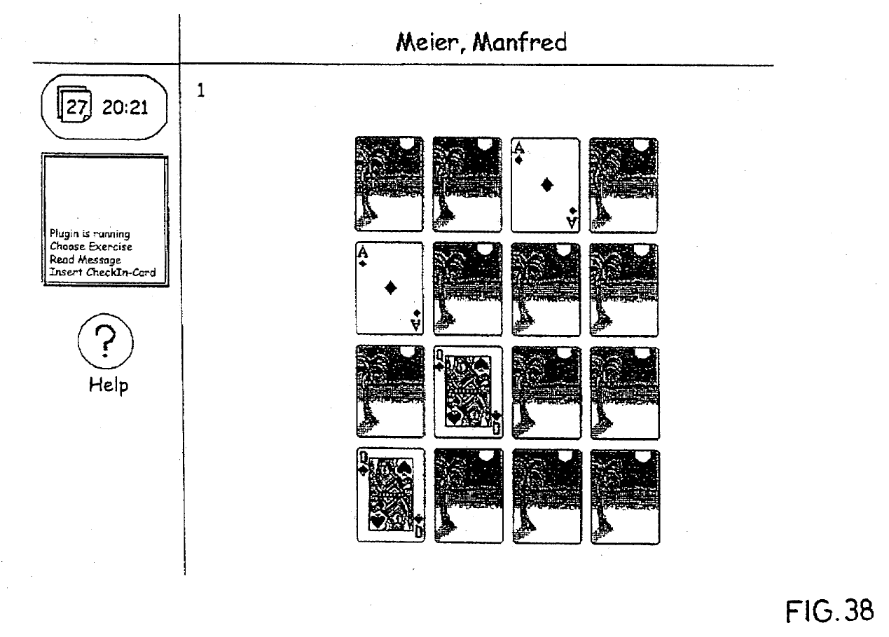

Afterwards, a choose-exercise user interface 31, 32 (FIG. 36, 37) is displayed. The patient can choose between different therapy programs suggested by the therapist. A choice like this is only possible in the case provided for in the configuration packet 85. The patient can not influence the parameter setting within the therapy program. According to the choice, a corresponding interaction screen 33 (FIG. 38) is displayed. With its aid, the patient executes the therapy training. If necessary, an external therapy sensor 81 is connected with the patient computer 59.

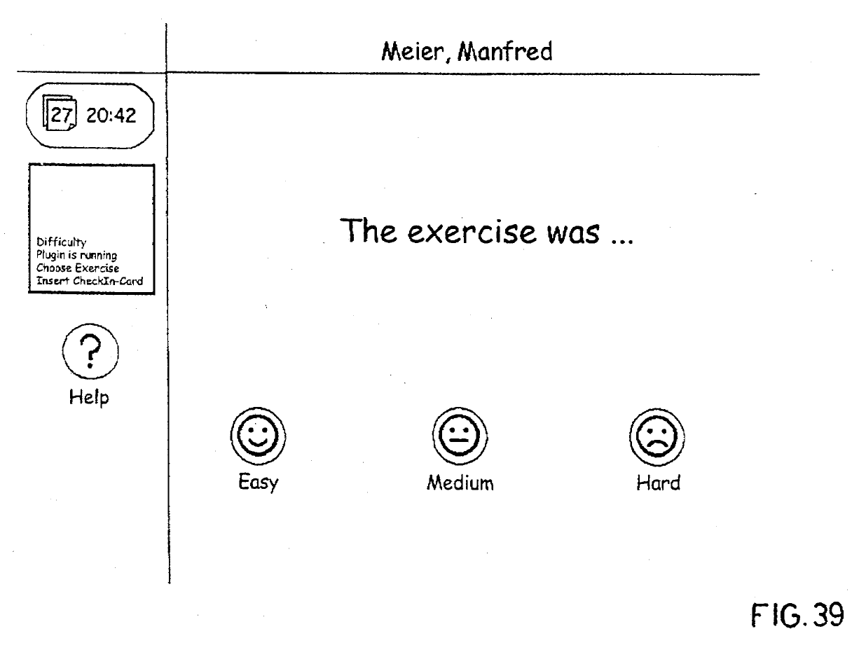

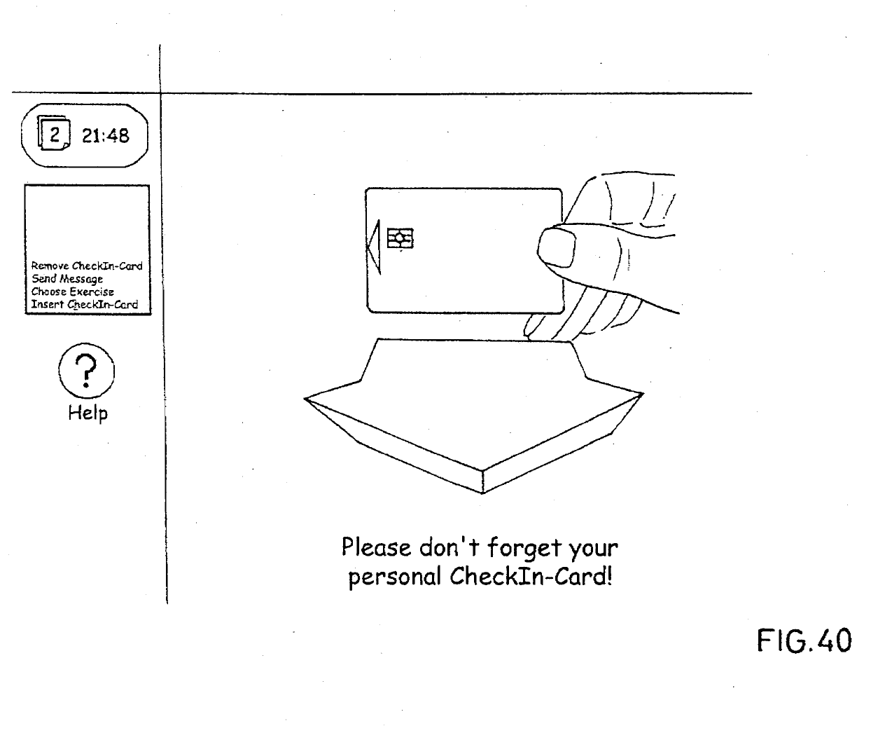

After successful therapy training, the patient receives a note concerning the difficulty level of the just finished therapy program via an information screen 34 (FIG. 39). In the end, the patient is requested via a finish screen 35 (FIG. 40) to remove the identification card 79 out of the identification module 77.

The data communication between the therapist computers 42 to 44 and the patient computers 45 to 47 respectively 59 to 63 can be supported by a data management program like ASP (Application Service Providing).

What is claimed:

1. A therapy system comprising at least one therapist computer for the processing of therapy programs and at least one patient computer that in the course of the therapy is connected at least temporarily with a therapy sensor and with the therapist computer via a data network;
wherein it communication module (64, 71) controlling the data flow between the therapist computer (42 to 44) and the patient computer (45 to 47, 59 to 63) is designed such that in the beginning of a therapy session, a configuration packet (85) is transmitted from the therapist computer (42 to 44) to the patient computer (45 to 47, 59 to 63) that controls the release of at least one particular therapy program already preloaded on the patient computer (45 to 47, 59 to 63).

2. A therapy system according to claim 1, wherein the patient computer (45 to 47, 59 to 63) is connected with an identification module (77) to identify the patient.

3. A therapy system according to claim 2, wherein the identification module (77) is designed in such a way that the therapy can only take place whilst the identification module (77) has access to the identification card (79).

4. A therapy system according to claim 2, wherein the communication module (64, 71) is designed in such a way that after identification of the patient the therapy program is automatically released.

5. A therapy system according to claim 1, wherein the communication module (64, 71) is designed in such a way that via the configuration packet (85) data are transmitted that represent a maximum number of repetitions of the corresponding therapy program.

6. A therapy system according to claim 1, wherein the communication module (64, 71) is designed in such a way that via the configuration packet (85) data are transmitted that represent the specific, individually patients orientated therapy information of the corresponding therapy program.

7. A therapy system according to claim 1, wherein the communication module (64, 71) is designed in such a way that additionally to the configuration packet (85) messages between the therapist and the patient can be transmitted.

8. A therapy system according to claim 1, wherein the communication module (64, 71) is designed in such a way that the configuration packet (85) during transmission from the therapist computer (42 to 44) to the patient computer (45 to 47, 59 to 63) is cached on a server (53).

9. A therapy system according to claim 1, wherein the communication module (64, 71) is designed in such a way that in the end of a therapy session, a data packet containing the results (85) is transmitted from the patient computer (45 to 47, 59 to 63) to the therapist computer (42 to 44).

10. A therapy system according to claim 9, wherein the communication module (64, 71) is designed in such a way that the data packet containing the results (85) is cached on the server (53) during transmission from the patient computer (45 to 57, 59 to 63) to the therapist computer (42 to 44).

11. A therapy system according to claim 9, wherein the communication module (64, 71) is designed in such a way that via the data packet containing the results (85) other data arc transmitted representing the performance of the patient when executing the corresponding therapy program.

12. A therapy system according to claim 9, wherein the communication module (64, 71) is designed in such a way that via the data packet containing the results (85) other data are transmitted representing the specific, individually patient-orientated information on the results achieved with the corresponding therapy program.

13. A therapy system according to claim 1, wherein the communication module (64, 71) co-operates with a data encryption and data decoding module (66, 73).

14. A therapy system according to claim 1, wherein the therapist computer (42 to 44) features a data management module (70) for managing the data of the therapist computer (42 to 44).

15. A therapy system according to claim 1, wherein the data network (51) is one of a group containing a FR or a VPN.

16. A therapy method comprising the following method steps:
a) creation of at least one therapy program that can be executed with the aid of a computer;
b) installation of the therapy program on at least one patient computer;
c) producing a therapy plan;
d) transmission of therapy information representing the therapy plan from the therapist computer to the patient computer;
e) execution of the therapy plan by the patient with the aid of the patient computer;
wherein
f) configuration information (85) is transmitted as therapy information (88) that in the beginning of a therapy session manages the release of at least one particular therapy program already preloaded on the patient computer.

17. A therapy method according to claim 16, wherein via the patient computer (45 to 47, 59 to 63) an identification (87) of the patient takes place before any therapy information is transmitted.

18. A therapy method according to claim 16, wherein the release (89) of the therapy program is automatically carried out after successful identification (87) of the patient.

19. A therapy method according to claim 16, wherein along with the configuration information other data are transmitted (88) that represent the maximum number of repetitions of the corresponding therapy program.

20. A therapy method according to claim 16, wherein along with the configuration information other data are transmitted (88) that represent specific, individually patient-orientated therapy information on the corresponding therapy program.

21. A therapy method according to claim 16, wherein during transmission from the therapist computer (42 to 44) to the patient computer (45 to 47, 59 to 63), the configuration information (85) are cached on a server (53).

22. A therapy method according to claim 167 wherein in the end of a therapy session data containing information on the results (85) are transmitted (92) from the patient computer (45 to 47, 59 to 63) to the therapist computer (42 to 44).

23. A therapy method according to claim 22, wherein the data containing information on the results (85) are cached (93) on a server (53) during transmission (92) from the patient computer (45 to 47, 59 to 63) to the therapist computer (42 to 44).

24. A therapy system according to claim 22, wherein along with the data containing information on the results (85) other data are transmitted (92) that represent the performance of the patient when executing (90) the corresponding therapy program.

25. A therapy method according to claim 22, wherein along with the data containing information on the results (85) other data are transferred (92) that represent specific, individually patient-orientated information on the results of the corresponding therapy program.

26. A therapy method according to claim 22, wherein via the information on the results (85) an adaptation (93) of the configuration information is done.

27. A therapy system according to claim 2, wherein the identification module (77) during identification cooperates with an identification card (79) containing the data assigned to the patient.

28. A therapy system according to claim 1, wherein the communication module (64, 71) is designed in such a way that, via the configuration packet (85), data are transmitted that represent a duration of the corresponding therapy program.

29. A therapy system according to claim 1, wherein the communication module (64, 71) is designed in such a way that, via the configuration packet (85), data are transmitted that represent the degree of difficulty of the corresponding therapy program.

30. A therapy system according to claim 1, wherein the therapist computer (42 to 44) features a data management module (70) for managing the data of the patients.

31. A therapy method according to claim 17, wherein an identification card (79) containing relevant data of the patient is used for the identification step (87).

32. A therapy method according to claim 16, wherein, along with the configuration information, other data are transmitted (88) that represent the duration of the corresponding therapy program.

33. A therapy method according to claim 16, wherein, along with the configuration information, other data are transmitted (88) that represent the degree of difficulty of the corresponding therapy program.
